(19) United States
(12) Patent Application Publication
(10) Pub. No.: US 2014/0215351 A1
(43) Pub. Date: Jul. 31, 2014

(54) GRADATION CODING TO EXPRESS SENTIMENT

(71) Applicant: Knotch, Inc., San Francisco, CA (US)

(72) Inventors: Anda Gansca, San Francisco, CA (US); Stephanie Volftsun, San Francisco, CA (US)

(73) Assignee: Knotch, Inc., San Francisco, CA (US)

(21) Appl. No.: 14/166,644

(22) Filed: Jan. 28, 2014

Related U.S. Application Data
(60) Provisional application No. 61/849,611, filed on Jan. 31, 2013.

(51) Int. Cl. G06F 3/0481; G06F 15/173

(52) U.S. Cl. CPC G06F 3/0481; G06F 15/17306
USPC 715/751

(57) ABSTRACT

Systems and methods for expressing sentiment regarding any subject using color are disclosed. A user selects a topic and a color to be associated with that topic. A color is selected via a color widget, from a plurality of colors, each color corresponding to a particular sentiment for selection by the user to be associated with that topic. The user optionally inputs a text entry associated with the topic. A processor analyzes a plurality of entries of selected colors associated with the topic received from a plurality of members and renders a graphical object composed of differently-colored bands, each band having a length commensurate with a respective proportion of member entries selecting that color for association with the topic. Network-based access for display of the graphical object associated with the topic is provided to a plurality of members.

### CROSS-REFERENCE TO RELATED APPLICATIONS

This application claims priority to and the benefit of, U.S. Provisional Patent Application No. 61/849,611, filed Jan. 31, 2013, titled “Gradation Coding to Express Sentiment,” the contents of which are incorporated herein by reference in their entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present invention relates generally to the field of electronic communications and, particularly to creation and exchange of content using color to express sentiment regarding the content.

### BACKGROUND

The popularity of social media in today's society is unprecedented. Social media commonly refers to the means of interactions among people in which they create, share, exchange, and comment regarding content(s) among themselves in virtual communities and networks. Social media typically refers to a group of internet-based applications that build on the ideological and technological foundations of Web 2.0 that allow the creation and exchange of user-generated content.

It is now believed by various media sources and scholars that social media has become one of the most powerful sources for news updates through platforms utilizing social networks. In addition, there has been an increase in mobile social media that has created opportunities to utilize social media for marketing research, sales, promotions, and customer relationship development, among others.

Present platforms rely almost exclusively on verbal commentary/narratives and/or the “like” feature available in many platforms from users for expressing opinions about any subjects. This approach suffers from a number of disadvantages. Some users may not want to leave a comment, especially a comment expressing emotion or sentiment about a particular subject for a number of reasons, for example, the user may not want to write out a comment, the user might be shy about leaving a written comment, or there may be other factors that may lead some users to abstain from leaving written comments.

### SUMMARY OF THE INVENTION

Some embodiments discussed herein relate to unique systems and methods for expressing sentiment regarding any subject using color. A plurality of colors is provided to users for selection. Each color is associated with a particular sentiment, for example, varying degrees of positive sentiment, negative sentiment, and a neutral sentiment. The user selects the color based on the user's sentiment towards a particular subject. The systems and methods discussed herein may be embodied in a social networking platform.

While a variety of social networking platforms and other solutions for exchanging electronic communications between users currently exist, there are no devices or methods that utilize gradations of form or matter, such as colors, numbers, letters, hot or cold depictions, etc., and any combinations thereof, to clearly and unambiguously express and code gradations in sentiment and feelings about various topics within social media or otherwise.

Expressing sentiment where the only action required from a user is the selection of a color associated with that sentiment is fast, easy, and intuitive; thus, users may be more willing to express sentiment in this manner. Moreover, color is universal across different cultures and languages, thus, users may leave meaningful comments or feedback using color regardless of which language(s) they speak.

Research and study of user behavior where users utilize color to express sentiment is less prone to error than systems relying on verbal comments. Systems relying on verbal comments inherently must rely on a classification of the comments as positive or negative based on the words used (e.g., the words of the users need to be classified as positive or negative). This type of analysis is typically performed by a computer and is prone to error, especially when words are used in ways different from their ordinary meaning—for example, when words are used in a sarcastic manner, when dual meaning is imparted to the words, etc. It is exceedingly difficult to account for this type of commentary in systems based on verbal comment; as a result, any study or research based on these results is inherently prone to error due to misclassification—for example, a sarcastic comment about a subject using positive words may be classified as positive despite the user intending an entirely different meaning for the particular comment. Using color to express sentiment does not suffer from these drawbacks. On a color chart, there is clear delineation between positive, neutral, or negative sentiment about the subject; thus, systems using color to express sentiment are not prone to error due to dual meaning or misclassification. In addition, users may elect to add optional narrative in addition to the color, providing additional data for further study and research.

Some embodiments of the present invention relate to unique and distinct means of inputting, stating, expressing, capturing, recording, transmitting, organizing, displaying, storing, and analyzing the levels and varying degrees of sentiment and feelings of users towards products, services, ideas, opinions, politics, and other matters by using a gradation scale of various forms and means, such as colors, ascending numbers, ascending letters, hot or cold depictions, etc., and any combination thereof.

Some embodiments described herein also relate to systems and methods for collecting, recording, transmitting, organizing, displaying, and analyzing the data collected from the users regarding the scale of sentiment and feelings, for instance, regarding consumers' satisfaction with the purchase of a particular product or service, regarding viewers' reaction to a latest episode of a TV show, etc.

Some embodiments described herein relate to a platform, for example, a social media platform, a social networking application, etc., that allows users or members to describe or express their sentiment about any topic using color. In some embodiments, a user may select a topic that other users have previously discussed (e.g., made entries about via the platform or commented on in e.g., online commentary section of a news article) or a user can independently create a brand-new topic.

In some embodiments, the platform provides suggestions as a user types regarding topics about which the user can express his or her sentiment. In some embodiments, a user can express sentiment regarding a news article (e.g., contemporaneously with reading the article), television show (e.g., after or during the airing of a particular episode), movie, news event, and any other subject about which a user may have an interest. In some embodiments, a user may select to receive notifications, for example, push notifications via a mobile phone or computer, e-mail notifications, text message notifications, etc., requesting the user to express sentiment regarding a particular subject—for example, the user may register with an application or another service and select to receive such notifications, for example, about a television show.

Once a user selects the topic of interest, in some embodiments, the user then selects a color from a plurality of colors to be associated with that topic to express the user's sentiment regarding that topic. In some embodiments, the color is selected via a color widget, for example, a color thermometer or another tool configured to display a plurality of colors for selection by the user, where one or more colors may be displayed to the user as the user is making the color selection.

In some embodiments, the color is selected by clicking or otherwise selecting the desired color on a color chart. In some embodiments, the color is selected by swiping or scrolling in a desired direction, for example, up or down to select the desired color and express the desired sentiment. In some embodiments, only some of the colors are displayed to a user at a given time. In some embodiments, a subset of all the available colors, for example, one color at a time, one group of colors at a time, etc. are displayed to a user at a given time. In some embodiments, only the colors associated with, for example, positive sentiment, negative sentiment, or neutral sentiment are displayed at a given time.

In some embodiments, a legend regarding the meaning of each color is displayed to a user as the user clicks, taps, or scrolls over to the desired color. In some embodiments, the legend is displayed to the user even if the user does not ultimately select a particular color. In some embodiments, the legend associated with each color is different. In some embodiments, the legend explains the sentiment associated with each color selection. In some embodiments, the sentiment ranges from extremely positive to extremely negative. In some embodiments, the sentiment ranges from, for example, extremely hot, very hot, hot, somewhat positive, mildly positive, neutral, mildly negative, somewhat negative, cold, very cold, extremely cold. In some embodiments, the colors associated with each sentiment include red, bright orange, orange, yellow, pale yellow, white, pale blue, teal, light blue, purple, dark blue. In some embodiments, each entry by the user is displayed in the selected color. In some embodiments, each entry is posted to a timeline associated with that user and/or posted to a timeline associated with the selected topic and/or posted in a comment section. In some embodiments, each entry by the user is displayed in a box having a border drawn in the selected color. In some embodiments, the entry does not include any user-generated narrative associated therewith, for example, the displayed entry is a block of color regarding the selected topic, with no text being included within the block of color.

In some embodiments, in addition to selecting a color, a user has the option of posting an optional narrative regarding the selected topic. In some embodiments, the narrative may include any statements from the user regarding the selected topic.

In some embodiments, once a user selects the topic and color, and optionally provides a narrative regarding the topic, that user's input is displayed to other users who browse this topic and/or to users who visit that user's home page and/or to followers of that user (e.g., via a chronological listing). In some embodiments, each user has a home page associated with that user. In some embodiments, each user has a graphical object, for example, a color thermometer, associated with that user. In some embodiments, each topic has a graphical object, for example, a color thermometer, associated with that topic. In some embodiments, the graphical object is composed of a plurality of different-colored bands. In some embodiments, the presence of each color of the plurality of different colors within the graphical object is determined based on entries (knotches) posted by users, for example, each color is present only if a user has previously selected that color for an entry. In some embodiments, the color white represents neutral sentiment regarding a topic—if no user has previously selected the color white for a particular topic, no white bands would be present within the graphical object associated with that object. In some embodiments, the length of each band of the plurality of different-colored bands is determined by the number of users who have used that particular color for expressing their sentiment regarding the chosen topic (e.g., the higher the number of users and/or entries using a particular color, the longer the length of the band of that particular color).

In some embodiments, every time a user posts an entry (e.g., color sentiment regarding a particular topic with optional written comment) a graphical object associated with that particular user is updated and/or a graphical object associated with that particular topic is updated. In some embodiments, the updates of color are performed in real-time. In some embodiments, the updates are performed contemporaneously with an event taking place, for example, a live event such as an awards ceremony, sporting event, developing news event, etc.

In some embodiments, other users of the platform may “like” or comment on other users' expressed sentiment regarding the subject—for example, once a first user's entry (knotch) regarding a particular topic is displayed, other users may “like” it and/or leave a comment regarding the first user's sentiment. In some embodiments, a “dislike” feature is provided, and other users may “dislike” an entry by another user.

One aspect described herein relates to a method for structuring and displaying compiled sentiment data on a plurality of user-specified and/or user-selected topics. The method includes receiving, over a network from a first user computing device, an entry by a first member. The entry includes a first selected topic, for example, said first selected topic chosen from a displayed listing of “trending” topics, or from a group of displayed topics within a selected category, or topic entered by the first member via a text box or other widget. The method also includes displaying, to the first user computing device, a widget including a plurality of colors, each color corresponding to a particular sentiment for selection by the first member to be associated with the first selected topic. The method also includes receiving, over the network, from the first user computing device, a selection of a color by the first member corresponding to a particular sentiment to be associated with the first selected topic (e.g., and optionally, receiving, over the network, from the first user computing device, a text entry, e.g., a comment, made by the first member associated with the first selected topic). The method further includes providing, to a plurality of members, network-based access for review of the selection by the first member of the color associated with the first selected topic. The method also includes compiling, by a processor of a computing device, a plurality of entries of selected colors associated with the first selected topic received from a plurality of members and rendering a substantially linear graphical object, for example, a color thermometer, composed of differently-colored bands, each band having a length commensurate with a respective proportion of member entries selecting that color for association with the first selected topic. The method also includes providing, to a plurality of members, network-based access for display of the graphical object associated with the first selected topic (e.g., and, optionally, for display of a first widget identifying the first member and the color selected by the first member associated with the first selected topic, and for display of the text entry made by the first member associated with the first selected topic).

In some embodiments the method further includes receiving a request from the first user computing device to follow the first selected topic. In some embodiments the method further includes receiving a request from the first user computing device to follow a second user computing device. In some embodiments the first user computing device is registered with a social networking platform. In some embodiments the method further includes providing to the first user computing device a plurality of topics organized by category, for example, music, health, current events, miscellaneous, etc. In some embodiments the method further includes, upon receiving a selection of a category from the first user computing device, displaying to the first user computing device a plurality of sub-topics within the selected category. For example, if the selected category is music, the method includes providing a list of sub-topics within the category “music,” for example, the sub-topics may include a particular artist or artists, songs, concerts, album releases, etc. In some embodiments, the method further includes displaying to the first user a graphical object (e.g., a color thermometer) associated with each sub-topic.

In some embodiments the method further includes updating the graphical object in real time (e.g., as updates are made by users). In some embodiments updating the graphical object includes adjusting the length of each differently-colored band based on entries received from all users on the first selected topic (e.g., wherein adjusting also includes adding a band of a new color if no users have previously selected the new color for association with the first selected topic). In some embodiments the length of the graphical object remains constant (e.g., only the lengths of the different bands of color within the graphical object change). In some embodiments the method further includes displaying the graphical object directly underneath each sub-topic. In some embodiments the graphical object includes 11 colors. In some embodiments the graphical object includes yellow, blue, and white colors. In some embodiments the graphical object includes a first group of colors (e.g., red, orange, yellow) indicating varying degrees of positive sentiment associated with the first topic. In some embodiments the graphical object includes a second group of colors (e.g., dark blue, blue, light blue) indicating varying degrees of negative sentiment associated with the first topic. In some embodiments the graphical object includes colors positioned on opposite ends of the visible color spectrum (e.g., colors in both the red and blue portions of the visible spectrum).

One aspect described herein relates to a system for structuring and displaying compiled sentiment data on a plurality of user-specified and/or user-selected topics. The system includes a processor and a memory. The memory includes instructions that are executed by the processor. The instructions cause the processor to receive, over a network from a first user computing device, an entry by a first member. The entry includes a first selected topic (e.g., said first selected topic chosen from a displayed listing of “trending” topics, or from a group of displayed topics within a selected category, or topic entered by the first member via a text box or other widget). The instructions also cause the processor to display, to the first user computing device, a widget comprising a plurality of colors, each color corresponding to a particular sentiment for selection by the first member to be associated with the first selected topic. The instructions also cause the processor to receive, over the network, from the first user computing device, a selection of a color by the first member corresponding to a particular sentiment to be associated with the first selected topic (e.g., and optionally, receiving, over the network, from the first user computing device, a text entry, e.g., a comment, made by the first member associated with the first selected topic). The instructions also cause the processor to provide, to a plurality of members, network-based access for review of the selection by the first member of the color associated with the first selected topic. The instructions also cause the processor to compile a plurality of entries of selected colors associated with the first selected topic received from a plurality of members and render a substantially linear graphical object (e.g., a color thermometer) composed of differently-colored bands, each band having a length commensurate with a respective proportion of member entries selecting that color for association with the first selected topic. The instructions also cause the processor to provide, to a plurality of members, network-based access for display of the graphical object associated with the first selected topic (e.g., and, optionally, for display of a first widget identifying the first member and the color selected by the first member associated with the first selected topic, and for display of the text entry made by the first member associated with the first selected topic).

One aspect described herein relates to a non-transitory computer readable medium having instructions stored thereon. The instructions, when executed by a processor, cause the processor to receive, over a network from a first user computing device, an entry by a first member. The entry includes a first selected topic (e.g., said first selected topic chosen from a displayed listing of “trending” topics, or from a group of displayed topics within a selected category, or topic entered by the first member via a text box or other widget). The instructions also cause the processor to display, to the first user computing device, a widget comprising a plurality of colors, each color corresponding to a particular sentiment for selection by the first member to be associated with the first selected topic. The instructions also cause the processor to receive, over the network, from the first user computing device, a selection of a color by the first member corresponding to a particular sentiment to be associated with the first selected topic (e.g., and optionally, receiving, over the network, from the first user computing device, a text entry, for example, a comment, made by the first member associated with the first selected topic). The instructions also cause the processor to provide, to a plurality of members, network-based access for review of the selection by the first member of the color associated with the first selected topic. The instructions also cause the processor to compile a plurality of entries of selected colors associated with the first selected topic received from a plurality of members and render a substantially linear graphical object, for example, a color thermometer, composed of differently-colored bands, each band having a length commensurate with a respective proportion of member entries selecting that color for association with the first selected topic. The instructions also cause the processor to provide, to a plurality of members, network-based access for display of the graphical object associated with the first selected topic (e.g., and, optionally, for display of a first widget identifying the first member and the color selected by the first member associated with the first selected topic, and for display of the text entry made by the first member associated with the first selected topic).

Elements of embodiments described with respect to a given aspect of the invention may be used in various embodiments of another aspect of the invention. For example, it is contemplated that features of dependent claims depending from one independent claim can be used in apparatus, articles, systems, and/or methods of any of the other independent claims.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIGS. 1(a)-1(d) are screen shots of a profile page of a user of a social networking application, in accordance with certain embodiments of the invention.

FIGS. 1(e) and 1(f) are screen shots of topics pages within a social networking application, in accordance with certain embodiments of the invention.

FIG. 2(a) is a screen shot of a topic list within a social networking application, in accordance with certain embodiments of the invention.

FIGS. 2(b)-2(i) are screen shots illustrating how an entry is generated within a social networking application, in accordance with certain embodiments of the present invention.

FIG. 3(a) is a screen shot of a list of notifications within a social networking application, in accordance with certain embodiments of the invention.

FIGS. 4(a) and 4(b) are screen shots illustrating suggestions for topics generated by a social networking application, in accordance with certain embodiments of the invention.

FIG. 5(a) is a screen shot of a page associated with a topic, in accordance with certain embodiments of the invention.

FIGS. 5(b) and 5(c) are screen shots illustrating generating of an entry by a user regarding the topic shown in FIG. 5(a), in accordance with certain embodiments of the invention.

FIG. 6(a) is a screen shot of a listing of hot topics along with graphical elements associated with each of the hot topics, in accordance with certain embodiments of the invention.

FIGS. 6(b) and 6(c) are screen shots of a page associated with one of the hot topics displayed in FIG. 6(a), in accordance with certain embodiments of the invention.

FIG. 7 is a screen shot of a news article with a graphical object embedded within the news article, in accordance with certain embodiments of the invention.

FIG. 8 is a screen shot of a graphical object for rating content displayed on a web page, in accordance with certain embodiments of the invention.

FIG. 9 is a screen shot of two example charts generated based on color rating data generated by users.

FIG. 10 is a block diagram of an example network environment for use in the methods and systems for analysis of spectrometry data, according to an illustrative embodiment.

FIG. 11 is a block diagram of an example computing device and an example mobile computing device, for use in illustrative embodiments of the invention.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DESCRIPTION

It is contemplated that apparatus, articles, methods, and processes of the claimed invention encompass variations and adaptations developed using information from the embodiments described herein. Adaptation and/or modification of the apparatus, articles, methods, and processes described herein may be performed by those of ordinary skill in the relevant art.

Throughout the description, where apparatus and articles are described as having, including, or comprising specific components, or where processes and methods are described as having, including, or comprising specific steps, it is contemplated that, additionally, there are apparatus and articles of the present invention that consist essentially of, or consist of, the recited components, and that there are processes and methods according to the present invention that consist essentially of, or consist of, the recited processing steps.

It should be understood that the order of steps or order for performing certain actions is immaterial so long as the invention remains operable. Moreover, two or more steps or actions may be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim.

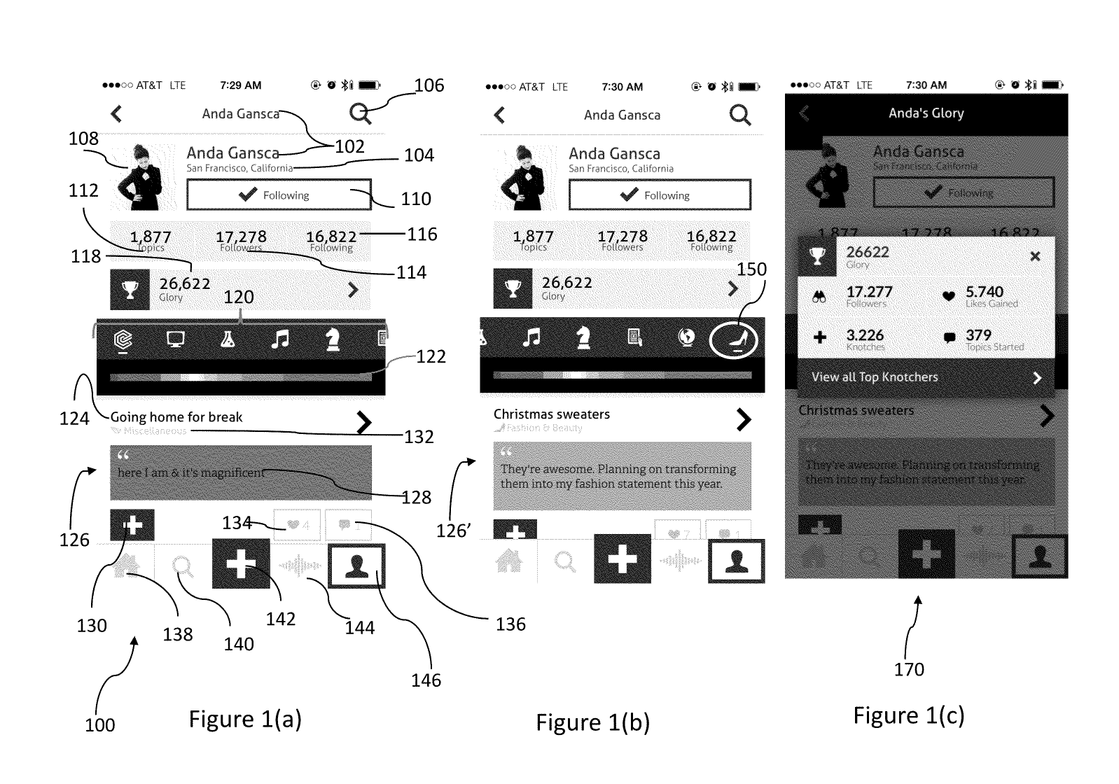

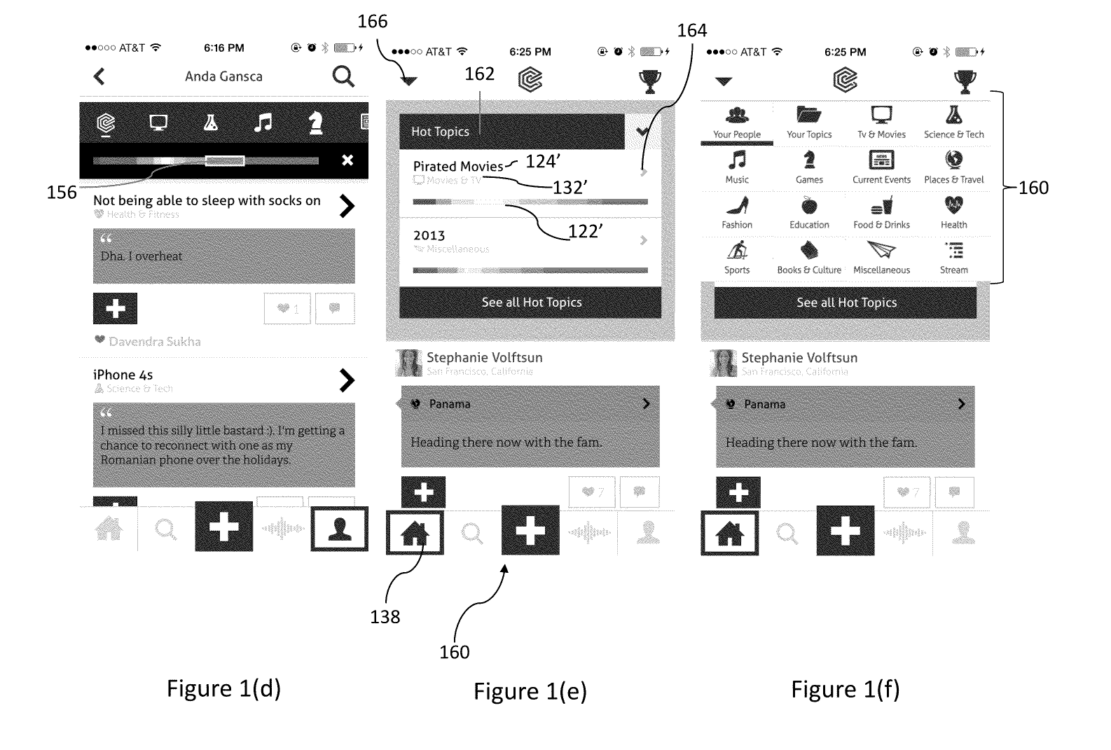

Referring now to FIG. 1(a), a screen shot 100 of a page of a user or member 102 of a social networking platform is shown. The user page may be displayed via an interface, including a monitor, a smartphone display, a computer display, a tablet display, etc. In some embodiments, the user or member 102 registers directly with the social networking platform. In some embodiments, registering with the social networking platform includes creating or providing user credentials, for example, username and password. In some embodiments, the user or member 102 signs into the social networking platform by using credentials from another social networking platform, for example, FACEBOOK®, TWITTER®, etc. In some embodiments, the user or member 102 is a human user. In some embodiments, the user or member 102 is a non-human user.

Although the elements are shown as being organized in a particular manner in the screen shot 100 of FIG. 1(a), those of skill in the art will appreciate that the layout of the different icons or widgets in the below-referenced figures may be changed or modified, e.g., depending on user settings. In some embodiments, a widget is a control button. The screen shot 100 is displayed to other users or members who visit the homepage of the user 102. In some embodiments, users or members do not need to be followers of the user 102 to visit the homepage associated with the user 102. In some embodiments, some elements displayed on the screen shot 100 are only visible to users or members that were previously granted permission by the user 102 to view that user's homepage (e.g., via a request to the user 102). A variety of security and/or privacy features known to those skilled in the art may be incorporated into systems and methods described herein.

In the upper center portion of the screen shot 100, a name, for example, first and last name or first name and last initial or another identifying characteristic, for example a username or a nickname, of the user 102 is displayed. In some embodiments, the name may either be a full name or, e.g., shortened name, for example, first name and last initial, and is configurable by the user or member 102. In accordance with some embodiments, some settings are configurable by the user or member 102 and some settings are predetermined by the social networking application. In some embodiments, underneath the name 102, a narrative 104 regarding the user 102 is provided, e.g., city and state where the user 102 is currently located. In some embodiments, the narrative 104 may include any information provided by the user 102. In some embodiments, the narrative 104 includes details that the user 102 would like displayed underneath the name—for example, user's interests, occupation, hobbies, etc. In some embodiments, the narrative 104 is configurable by the user 102. In the upper right corner of the screen shot 100, a search widget 106 is provided. Selecting or clicking the widget 106 takes a user to a search screen. In some embodiments, clicking the widget 106 takes a user to a search screen where a user is prompted to search entries (knotches) associated with and/or generated by the user 102.

In the upper left corner of the screen shot 100, an icon or picture 108 associated with the user 102 is provided. In some embodiments, the icon or picture 108 is selectable or configurable based on user settings (e.g., selected by the user 102). In some embodiments, the icon or picture 108 is selected based on icons or pictures used by the user 102 in other social networking platforms, for example, FACEBOOK®, TWITTER®, etc.

An indicator 110 specifies whether a user viewing the home page of the user 102 is a follower of the user 102. A topic counter 112 indicates a total number of topics (e.g., a total number of different topics) regarding which the user 102 has made entries. The topic counter 112 is increased each time that the user 102 makes a new entry regarding a new topic (e.g., a topic regarding which the user 102 has previously not made entries). A follower counter 114 indicates a total number of followers of the user 102. The follower counter 114 is increased each time that another user starts following the user 102 and is decreased each time that an existing follower stops following the user 102. A following counter 116 indicates a total number of other users that the user 102 follows. The following counter 116 is increased each time that the user 102 starts following another user and is decreased each time that the user 102 stops following another user.

A glory counter 118 sums together a total number of followers of the user 102, a total number of “likes” gained on entries made by the user 102, a total number of entries (“knotches”) made by the user 102, plus a total number of topics started by the user 102, for example, topics where the user 102 made the first entry. FIG. 1(c) shows a screen shot 170 when the glory counter 118 of FIG. 1(a) is pressed. As seen in FIG. 1(c), individual counters indicating, separately, (1) total number of followers of the user 102, (2) total number of “likes” gained on entries made by the user 102, (3) total number of entries (“knotches”) made by the user 102, (4) total number of topics started by the user 102, for example, topics where the user 102 made the first entry, are displayed.

A plurality of icons 120 is provided underneath the glory counter 118. In the view shown in the screen shot 100 of FIG. 1(a), the leftmost “knotch” icon is depressed. In this view shown in FIG. 1(a), all the entries (knotches) of the user 102 are displayed in chronological order (with the most recent entries being displayed on top). A user may navigate between the plurality of icons 120 by scrolling leftward or rightward. For example, as shown in FIG. 1(b), a user may scroll to the left (e.g., to display the icons located to the right of the icons shown in FIG. 1(a)) and select (press) “fashion” icon 150. Upon selecting the fashion icon 150, a chronological (with the most recent on top) listing of entries (knotches) of the user 102 organized under the topic of fashion is displayed. In some embodiments, each entry (knotch) is shown in a color that is selected by the user 102 to express a particular sentiment, as will be discussed in further detail below.

Underneath the plurality of icons 120, a graphical object 122 (e.g., a color thermometer) associated with all the entries (knotches) made by the user 102 is shown.

In some embodiments, the graphical object 122 includes 11 colors. In some embodiments, the graphical object 122 includes any desired number of colors. In some embodiments, 3, 5, 7, 9, 11, 13, 15, 17, 19, or 21 different colors are used. In some embodiments, any number of different colors between 3-25 or between 3-50 is used. In some embodiments, any number of colors separated by a band of color white is used. In some embodiments, the graphical object 122 includes a first group of colors and a second group of colors, the first group of colors being distinguishable from the second group of colors. In some embodiments, the first and second groups include colors that belong to two contrasting, easily distinguishable color families separated by a band of white color (indicating neutral sentiment). In some embodiments, the graphical object 122 includes three group of colors: a first group of color indicating positive sentiment, a second group of colors indicating negative sentiment, and a third group of colors (which may be a single color) indicating neutral sentiment. In some embodiments, the first group of colors is associated with negative sentiment and includes five colors, in order from left to right, dark blue, purple, light blue, teal, and pale blue (e.g., colors in the violet and blue portions of the visible spectrum). In some embodiments, the second group of colors is associated with positive sentiment and includes five colors, in order from left to right, pale yellow, yellow, orange, bright orange, red (e.g., colors in the yellow, orange, and red portions of the visible spectrum). In some embodiments, excluding the color white, the graphical object 122 includes colors having wavelengths that increase from left to right. In some embodiments, the graphical object 122 is displayed rotated 90 degrees counterclockwise from the view shown in FIG. 1(a) (e.g., the first group of colors is located on the bottom and the second group of colors is located on the top). In some embodiments, the graphical object 122 is oriented in any desired manner.

In some embodiments, the first group of colors is located to the left of the second group of colors. In some embodiments, the first group of colors is separated from the second group of colors by a band of color white (e.g., only if the user 102 has previously used the color white for making an entry (knotch)). In some embodiments, the first group of colors includes colors in the violet and blue portions of the visible spectrum. In some embodiments, the second group of colors includes colors in the yellow, orange, and red portions of the visible spectrum. In some embodiments, the first group of colors includes colors having a wavelength between about 380-500 nm. In some embodiments, the second group of colors includes colors having a wavelength between about 570-750 nm. In some embodiments, the graphical object 122 includes colors having a wavelength anywhere in the visible spectrum (e.g., between about 380-750 nm).

In some embodiments, the graphical object 122 includes colors red, bright orange, orange, yellow, pale yellow, white, pale blue, teal, light blue, purple, dark blue. The presence of each color on the graphical object 122 is determined based on entries (knotches) made by the user 102. A color only appears on the graphical object 122 associated with a user if that user has previously used that color to associate that color with a particular topic. If a user never uses a particular color, for example, if a user never uses the color white, then that color does not appear on the graphical object 122 associated with that user.

The width of each color band within the graphical object 122 is adjusted based on each entry (knotch) made by the user 102; the more entries the user 102 makes using a particular color, the wider the band of that color becomes (e.g., and the width of the other color bands within the graphical object 122 is adjusted accordingly). In some embodiments, the size (e.g., width and length) of the graphical object 122 remains constant (e.g., within the confines of the same display with the same settings, for example, if the graphical object 122 is displayed on a particular display, as long as the display/zoom settings remain unchanged, the width of the graphical object 122 on that display also remains the same), but the width of each of the different colored bands within the graphical object 122 is adjusted based on each user entry. The width of each color band within the graphical object 122 is made in real-time, for example, as soon as the user 102 makes an entry in a selected color, the width of each of the color bands within the graphical object 122 is adjusted accordingly.

In some embodiments, users may interact with each band of different color within the graphical object 122. In some embodiments, users may click on a band of any desired color within the graphical object 122. For example, a user may click on the bright orange colored tab 156 within the graphical object 122 to view all the entries (knotches) made by the user 102 using that color, for example, all entries that the user 102 selected to be associated with that color, for example, orange, as shown for example in FIG. 1(d).

In some embodiments, underneath the graphical object 122, a listing of entries (knotches) made by the user 102 is provided in chronological order (e.g., with the most recent entry being provided on top). Each entry 126 is associated with a topic 124, with the title, for example, “Going home for break” of the topic 124 being provided above each entry 126. As shown in FIG. 1(a), each entry 126 is displayed in a selected color (which will be discussed in further detail below). The color of each entry 126 corresponds to one of the plurality of colors within the graphical object 122.

Each topic 124 is also placed into or associated with a category 132, e.g., within a plurality of categories 160 shown in FIG. 1(f)). In some embodiments, each category 132 has an icon associated therewith. In some embodiments, the icon associated with each category 132 is one of the icons provided within the plurality of icons 120 and/or one of the icons provided within the listing of the plurality of icons associated with the plurality of categories 160 in FIG. 1(f). In some embodiments, each icon associated with the category 132 is selected from one of the plurality of icons shown as associated with the plurality of categories 160 shown in FIG. 1(f). In some embodiments, the plurality of categories 160 includes “Your People” (clicking which shows causes the entries (knotches) by the users that a user follows to be displayed in chronological order); “Your Topics” (clicking which shows the updates (knotches) made by any user regarding topic(s) that a user follows); “Tv & Movies”; “Science & Tech”; “Music”; “Games”; “Current Events”; “Places & Travel”; “Fashion”; “Education”; “Food & Drinks”; “Health”; “Sports”; “Books & Culture”; “Miscellaneous”; and “Stream”. In some embodiments, any number of categories 132 may be included. The categories 160 may be organized in any manner (e.g., categories may be displayed in any order). Each category of the plurality of categories 160 has an icon associated therewith as shown in FIG. 1(f).

For example, in FIG. 1(a), the topic 124 is “Going home for break” and the category 132 is “Miscellaneous.” In some embodiments, the category 132 is displayed directly underneath the topic 124. In some embodiments, the entry (knotch) 126 is displayed directly underneath the category 132. In some embodiments, the entry 126 includes a narrative 128, for example, the entry shown in FIG. 1(a). Each entry 126 is displayed in a color selected by the user 102. For example, in FIG. 1(a), the entry 126 is displayed in the color red and in FIG. 1(b), the entry 126′ is displayed in the color orange. The text of the narrative 128 is displayed in any color that is visible against the color of the entry 126 or 126′.

In some embodiments, a processor automatically places each entry 126 into a respective category 132 based on one or more predetermined criteria. In some embodiments, the user 102 selects the category 132 that the entry 126 should be placed into.

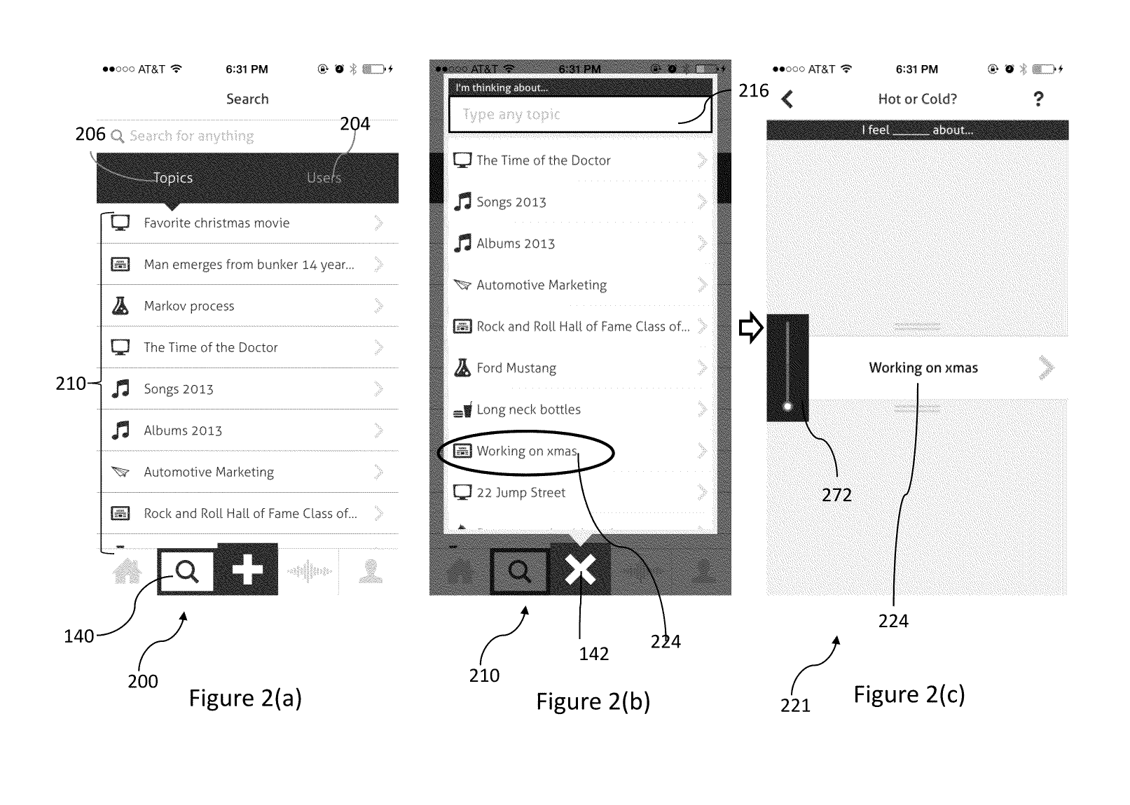

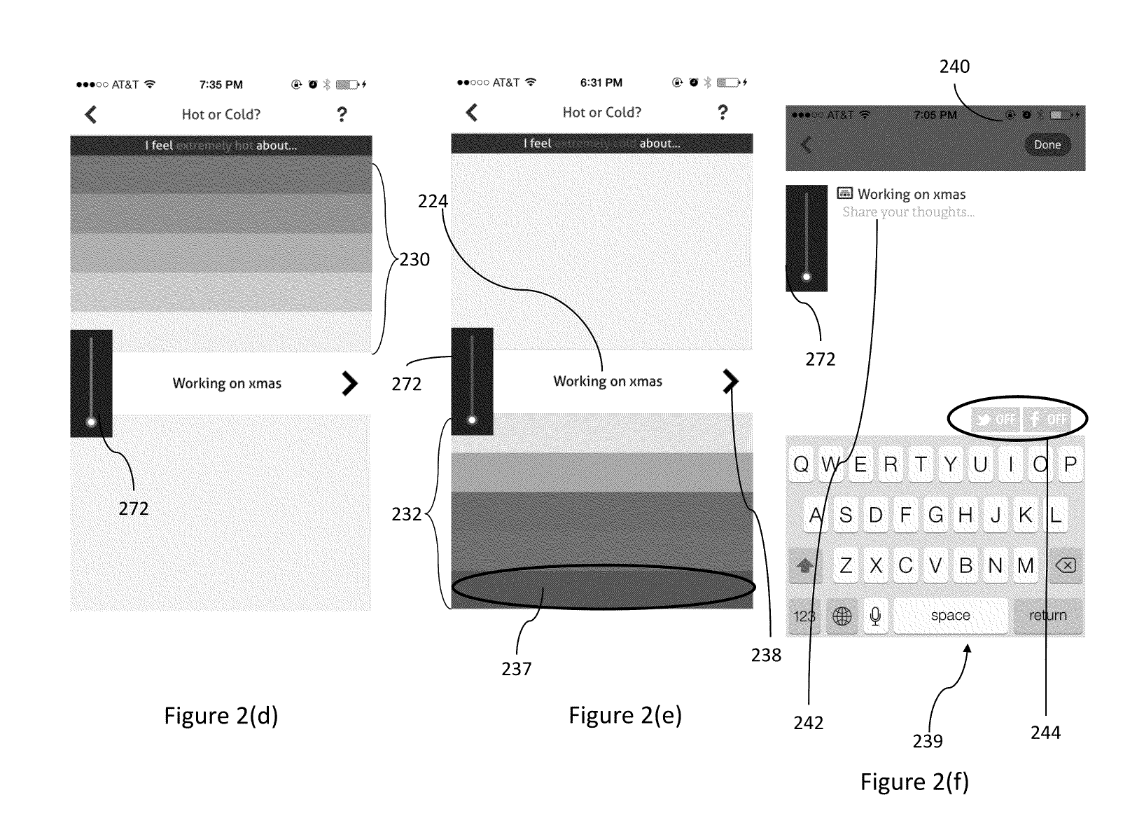

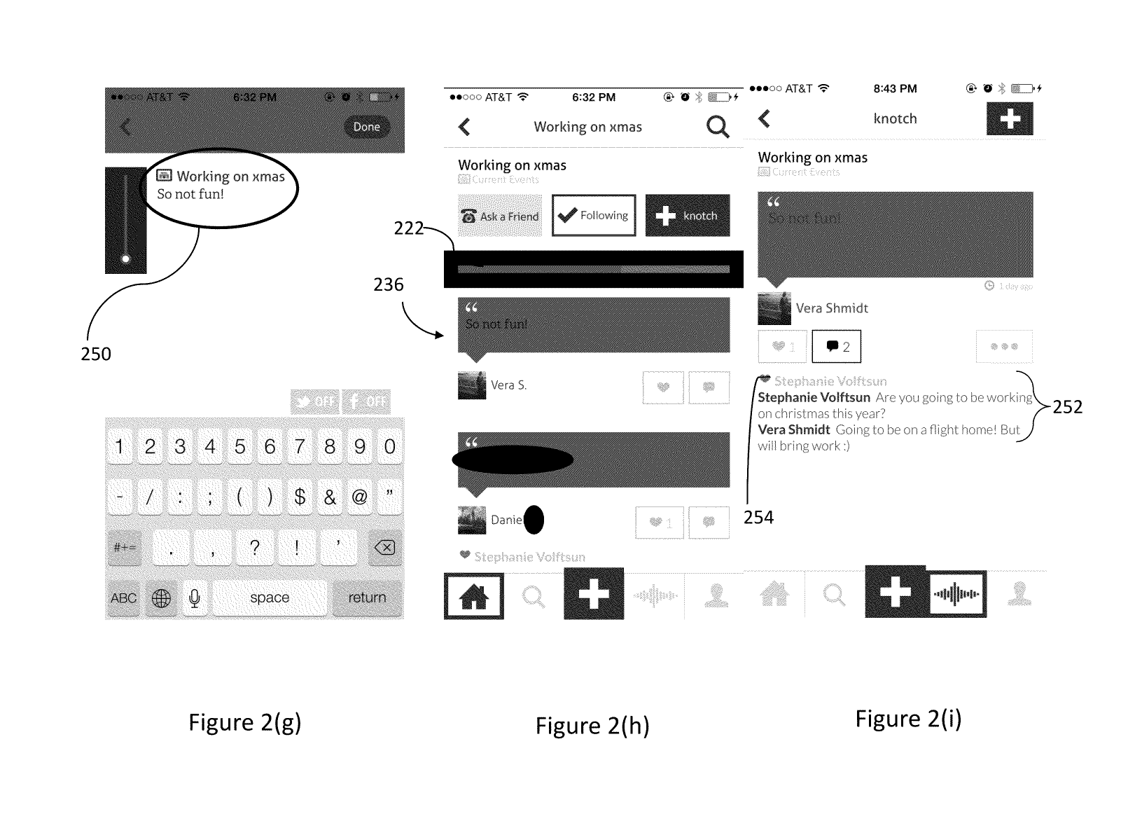

An “add entry” icon 130 is provided under each entry 126. Pressing the “add entry” icon 130 takes a user to an entry generation screen for example, similar to the one shown in FIG. 2(c), where a user selects a color to be associated with the particular topic and enters an optional narrative to be associated with the particular topic. For example, if the icon 130 underneath the entry 126 is pressed, a user is taken to a screen where a user may make an entry regarding the topic 124 “Going home for break.”

A “likes” icon 134 underneath the entry 126 indicates a total number of “likes” that the entry 126 received from users. A user may click the likes icon 134 to “like” any entry. A comment icon 136 underneath the entry 126 indicates the total number of comments that the entry 126 received from users. In some embodiments, a user may write a comment to describe that user's reaction to or otherwise provide commentary regarding the entry 126. In some embodiments, any user (including the user who generated the entry 126) may comment regarding the entry 126 (via the comment icon 136) or like the entry 126 (via the like icon 134).

A home icon 138 is provided on the bottom of the screen shot 100. In some embodiments, clicking the home icon 138 takes a user to the view shown in FIG. 1(e), where a listing of hot topics, for example, trending topics, is provided. A second search widget 140 is provided on the bottom of the screen shot 100. Clicking the second search widget 140 takes a user to the view including a list of topics shown in FIG. 2(a). An entry widget 142 is provided on the bottom of the screen shot 100. Clicking on the entry widget 142 takes a user to the view shown in FIG. 2(b), where a user may type in a desired topic or select a topic from a list of provided topics to make an entry (knotch).

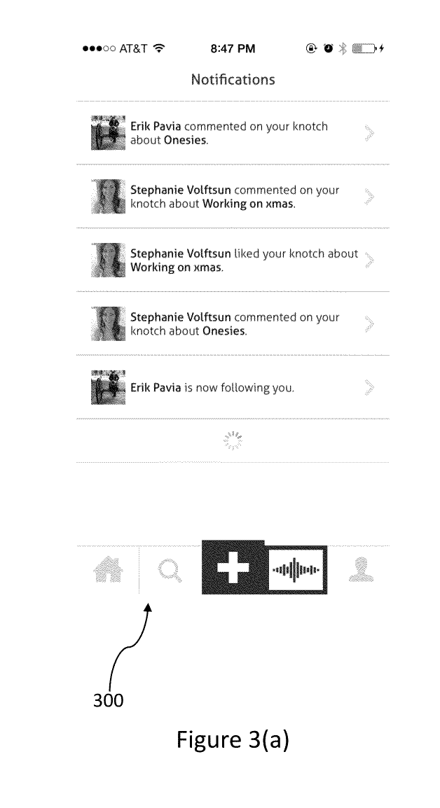

A notifications icon 144 is also provided on the bottom of the screen shot 100. Clicking the notifications icon 144 takes a user to a view showing recent notifications, as shown in screen shot 300 of FIG. 3(a). In some embodiments, the notifications include any comments made on user's entries (knotches) and/or any likes gained on user's entries (knotches). In some embodiments, notifications include a legend regarding any new users who have started following a particular user. The icon 144 changes its appearance, for example, becomes dark as shown in FIG. 3(a), when there are notification(s) that have not yet been seen by a user (e.g., when the user to whom notification(s) have issued has not yet looked through the notifications).

A profile icon 146 is provided on the bottom of the screen shot 100. Pressing the profile icon 146 takes a user back to his or her own profile page, for example, similar to the screen shot 100 of the profile page of the user 102 shown in FIG. 1(a).

Referring now to FIG. 1(b), a screen shot 148 of a user profile page with one icon, for example, the fashion icon 150, of the plurality of icons 120 being selected (pressed). Selecting the fashion icon 150 causes a processor to display to a user all the entries (knotches) of the user 102 (if any) that are categorized under the category “fashion.” In some embodiments, if the user has not made any entries categorized under a particular category, no entries (knotches) are displayed when that category is selected.

Referring now to FIG. 1(e), a screen shot 160 with the home icon 138 being pressed is shown. At the top of the screen shot 160, a listing of hot topics 162 is provided. In some embodiments, two hot topics are provided in the screen shot 160. In other embodiments, any desired number of hot topics are provided. Under the hot topics tab 162, a topic 124′, for example, “Pirated Movies” as shown in FIG. 1(e), and a category 132′ under which the topic 124′ is organized, for example, “Movies & TV”, are displayed. Underneath the topic 124′ and the category 132′, a graphical object 122′ associated with the topic 124′ is provided. A user can click on the topic 124′, the graphical object 122′ or the navigator tab 164 to see all entries (knotches) associated with that particular topic 124′.

In some embodiments, whether any topic is displayed under the hot topics tab 162 is determined by at least one of: number of entries on that particular topic and number of users interacting with that particular topic (e.g., generating entries, entering likes for any other user(s)' entries on that topic, viewing entries associated with that topic, etc.). In some embodiments, a topic appears in the hot topics tab based on other predetermined criteria, for example, prevalence in news media, trending topic in other social media, etc. In some embodiments, different hot topics are displayed to different users; for example, based on user interests or settings or based on system configuration.

Clicking the arrow 166 in FIG. 1(e) takes a user to a view shown in FIG. 1(f). FIG. 1(f) illustrates a plurality of categories 160 available for selection. In some embodiments, underneath the listing of hot topics in FIG. 1(e), when the “Your People” selection is made from the plurality of categories 160, a live feed of entries (knotches) from the users whom a particular user follows are shown in chronological order, for example, most recent entries are displayed on top.

Referring now to FIG. 1(a), clicking the second search widget 140 takes a user to the screen shot 200 shown in FIG. 2(a). A plurality of selectable topics 210 under a Topics category tab 206 are shown in FIG. 2(a); a user may select any topic of interest among the plurality of selectable topics 210. One advantage of the embodiments described herein is that a user does not need to build a large list of followers to achieve visibility, for example, to reach out to a large number of other users. In some embodiments, when a user creates an entry (knotch) about a particular topic, that user can immediately reach all the followers of that particular topic. A first user's entry (knotch) is visible to all users interested in that topic, whether or not those users follow the first user. Thus, users may more easily interact with and/or meet other users with e.g., similar interests based on their entries (knotches).

A user may also press a “Users” tab 204 to view a listing of users of the software application, for example, alphabetical order, most active user order, etc. A user may scroll upwards or downwards to find a desired topic, for example, a topic regarding which a user would like to make an entry or regarding which a user would like to see other users' entries (knotches).

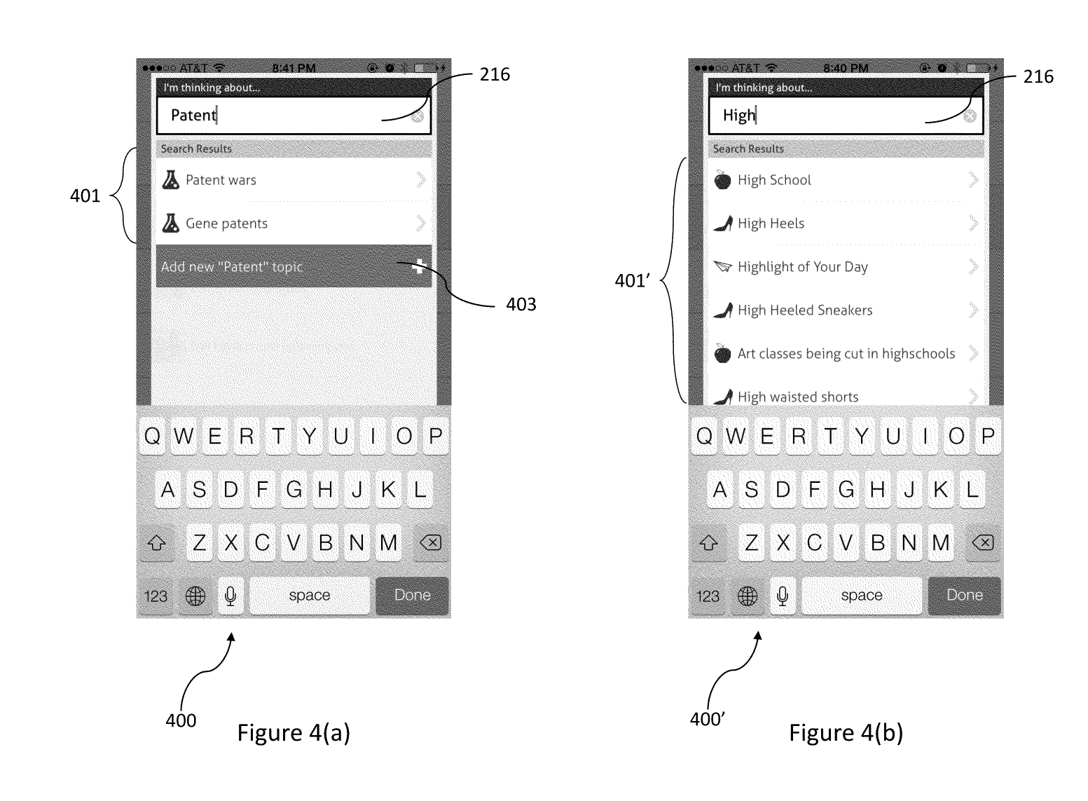

Clicking the entry widget 142 in FIG. 1(a) takes a user to the screen shot 210 shown in FIG. 2(b). A user may type a topic in field 216. A user may type any desired topic into the field 216. As shown in the screenshots 400 and 400′ in FIGS. 4(a) and 4(b), respectively, in some embodiments, various suggestions 401 and 401′ regarding topics are made to a user as a user types in a topic of interest into the field 216. A user may either select one of the provided suggestions from the plurality of suggestions 401 or 401′ or the user may choose to add a new topic, for example, by continuing typing in the field 216 or by clicking an “add new topic” widget 403.

Referring now to FIG. 2(b), a user may scroll down in the list of topics until a user reaches a topic of interest 224, for example, “Working on xmas.” A user may select the topic of interest 224, for example, by clicking on it, which takes a user to a screen shot 221 shown in FIG. 2(c). In FIG. 2(c), a sentiment thermometer 272 is provided to a user. The meaning (e.g., sentiment associated) with each color in the sentiment thermometer 272 is identical to the meaning (e.g., sentiment associated) with each color in the graphical object 122 discussed above. In some embodiments, the sentiment thermometer 272 has two color extremes—e.g., red and blue as shown in FIG. 2(c). The two color extremes are provided on opposite ends of the sentiment thermometer 272, for example, upper end and lower end; or left end and right end). In some embodiments, the selected topic 224 is displayed at a center of the screen shot 221. In some embodiments, the selected topic 224 is displayed anywhere on the screen shot 221. The user may scroll upwards (FIG. 2(d)) or downwards (FIG. 2(e)) from the view shown in FIG. 2(c) to choose a desired color to be associated with the selected topic 224. As the user scrolls upwards or downwards, in some embodiments, a legend associated with each color is provided, for example, legend “extremely hot” is provided for color red as shown in FIG. 2(d) and legend “extremely cold” is provided for color dark blue as shown in FIG. 2(e). The legend explains the meaning associated with each color to facilitate the selection of a color that best expresses the sentiment of the user regarding a particular subject, as discussed above in relation with the graphical object 122. A different sentiment is associated with each color to facilitate the expression of varying degrees of positive and negative (or neutral) sentiment by the user regarding a selected topic. In some embodiments, 11 different colors associated with 11 different sentiments (e.g., in the order from most positive to most negative: extremely hot, very hot, hot, somewhat positive, mildly positive, neutral, mildly negative, somewhat negative, cold, very cold, extremely cold) are available for selection by the user. The availability of a plurality of colors and associated sentiment makes it easier for a large number of users to express their emotions. For some people, it is more difficult to express sentiment verbally, but it is very easy to express sentiment by using color. Thus, the ability to select color associated with sentiment makes the systems and methods described herein more user-friendly and more accessible to a large number of users.

As shown in FIG. 2(d), five distinct colors 230 are shown as representing varying degrees of positive sentiment. As shown in FIGS. 2(d)-2(f), the sentiment thermometer 272 changes appearance, for example, changes color, as the user swipes up and down. In order from top to bottom, colors red, bright orange, orange, yellow, and pale yellow are displayed. As shown in FIG. 2(e), five distinct colors 232 are shown as representing varying degrees of negative sentiment. In order from top to bottom, colors pale blue, teal, light blue, purple, dark blue are displayed. A user may also select the color white by maintaining the selection in the middle, for example, by not scrolling upwards or downwards.

In some embodiments, a user has the ability to use swipe and drag features to express the gradation of feeling upwards or downwards. In some embodiments, a user drags a color spectrum upwards, for example, as shown in FIG. 2(d), to express positive sentiment or, alternatively, drags a widget, for example, a pointer or a selector, across or over a color spectrum. In some embodiments, a user drags a color spectrum downwards, for example, as shown in FIG. 2(e), to express negative sentiment.

As shown in FIG. 2(e), a user may select, for example, the color dark blue (237) to be associated with the selected topic 224, for example, “Working on xmas”. After the user selects the color, in some embodiments, the user is taken to a screen shot 239 shown in FIG. 2(f), where the user may leave an optional narrative, for example, regarding the selected topic 224, in field 242. The user also has an option to post the entry (knotch) to their FACEBOOK® and/or TWITTER® account (or another social networking account) (e.g., in addition to being posted to the social networking application within which the user is generating the entry). In some embodiments, the user may post the entry (knotch) to any desired platform, social media platform, or social networking platform. FIG. 2(g) shows a narrative 250 being made regarding the selected topic 224. FIG. 2(h) shows the entry 236 being posted to a top of a feed regarding the selected topic 224 (e.g., most recent entries are displayed on top). Any new entry regarding this topic will be posted above the entry 236. FIG. 2(i) shows comments 252 posted regarding the entry 236 and a like 254 posted regarding the entry 236. The entry 236 is displayed in the selected color 237.

After a user selects the color, a user is taken to the screen shown in FIG. 2(f), where a user may leave optional narrative regarding the topic. As shown in FIG. 2(g), a user may type a desired narrative. After clicking the “done” button or another button indicating that a user has completed the entry, a user is displayed all knotches associated with the selected topic, for example, “Working on xmas”, with the user's entry being placed at the top (unless another user has made an entry on the same topic more recently).

The graphical object 222 is updated each time a user posts a new entry 226. In some embodiments, the graphical object 222 is composed of one or more colors, depending on the color of the entries made by the users. In FIG. 2(h), the graphical object 222 is composed of only two colors—dark blue (signifying, for example, extremely cold sentiment regarding the topic) and purple, for example, signifying very cold sentiment regarding the topic, indicating that the users that have posted entries regarding the topic 222 (“Working on xmas”) have only used those two colors to express their sentiment.

Clicking on the entry 236 takes a user to a screen where the entry 236 is displayed, along with any comments 252 and/or likes 256 the entry 236, as shown in FIG. 2(i). In some embodiments, the comments 252 and/or likes 256 are displayed below the entry 236. In some embodiments, any user can make comments 252 and/or likes 256 regarding the entry 236. When a user receives a comment and/or a like, that user is notified of the same via the notifications tab 144 shown in FIG. 1(a); the notifications screen shot 300 shown in FIG. 3(a) illustrates some of the types of notifications that a user may receive.

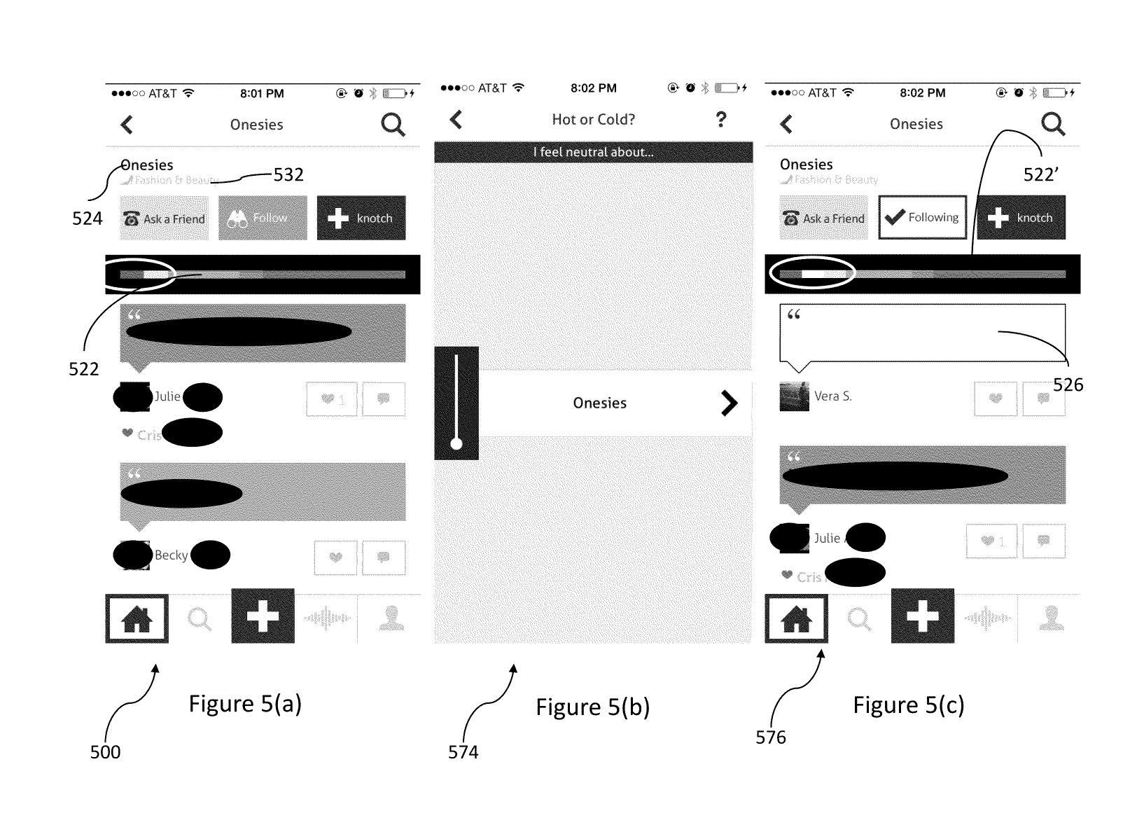

Referring now to FIG. 5(a), a screen shot 500 of all entries (knotches) 536 regarding a selected topic 520 (e.g., “Onesies”) in category 532 (“Fashion”) is displayed. The graphical object 522 associated with the selected topic 520 is displayed also. A user may make an entry regarding the selected topic. As shown in FIG. 5(b), a user may, for example, be “neutral” about the selected topic. Once the neutral entry is posted, the graphical object 522 is updated to reflect the posting of the neutral entry 526. As seen in FIG. 5(a), no “white” color bands are present on the graphical object 522 prior to the posting of the neutral entry 526. As seen in FIG. 5(c), a “white” color band appears on the graphical object 522′ after the entry 526 using the color “white” is posted. As seen in FIG. 5(c), the entry 526 does not need to include any narrative and may include only color. If desired, a user may include narrative with any entry 526. In some embodiments, once a user generates an entry regarding a particular topic, that user automatically starts following the particular topic. In some embodiments, a user may configure manually or be prompted by the platform whether or not the user starts following a particular topic once that use makes an entry (knotch) regarding that particular topic.

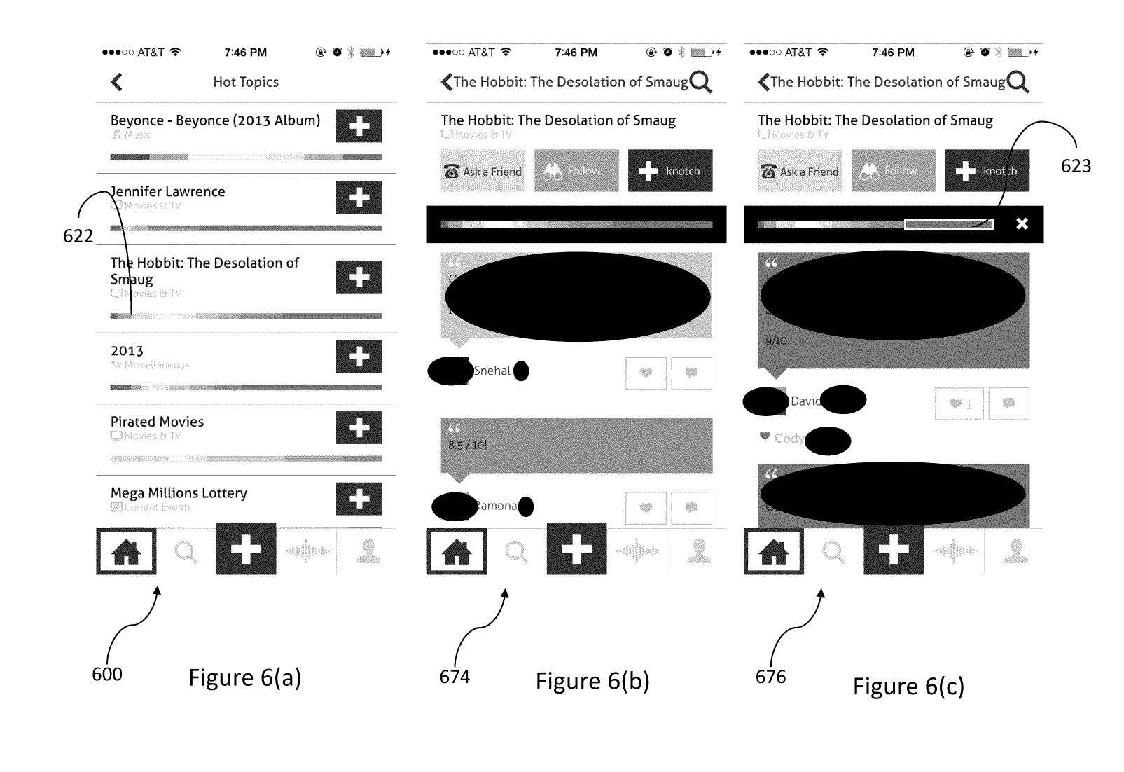

Referring now to FIG. 6(a), a listing of hot topics 680 is provided. Each hot topic has a graphical object 622 associated therewith. A user may choose any desired hot topic to make an entry (knotch) regarding that topic and/or to view other users' entries (knotches) regarding that hot topic. Screen shot 674 of FIG. 6(b) shows entries regarding the topic “The Hobbit: The Desolation of Smaug” within the category “Movies & TV.” Screen shot 676 shown in FIG. 6(c) shows all entries in color “red” (expressing the “extremely hot” sentiment regarding the topic); this view is obtained by selecting the red band 623 within the graphical object 622. In some embodiments, a user also has an option of sending a request to other users to enter their opinion (sentiment) regarding the selected topic and/or following the selected topic.

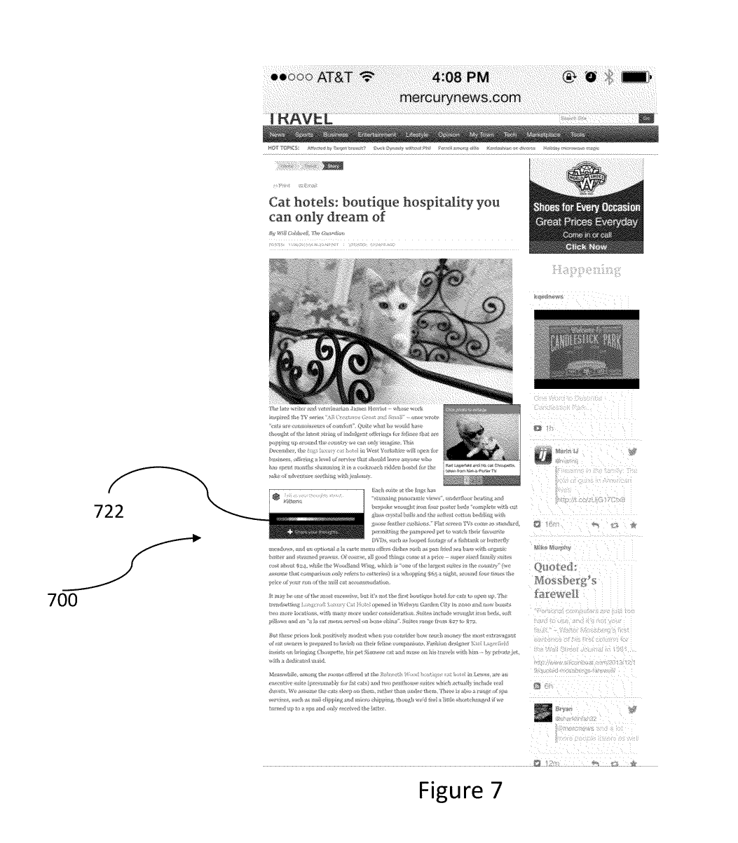

Referring now to FIG. 7, a screen shot 700 of a web page including a graphical object 722 embedded therein is illustrated. The graphical object 722 may be embedded anywhere on the page, for example, on top of page, bottom of page, middle of page, etc. In some embodiments, the graphical object 722 includes a plurality of colors available for selection by users to express sentiment regarding a topic associated with the content of the web page. For example, in some embodiments, the web page includes a news article about a cat or kittens, and the graphical object 722 may include a legend associated therewith prompting viewers of the web page to generate an entry, for example, regarding cats, kittens, some particular breed of cats, or regarding any other topic mentioned in the news article or in any way related to the news article. For example, in FIG. 7, the legend associated with the graphical object 722 prompts the viewers to share their thoughts regarding kittens. In some embodiments, the graphical object 722 includes a legend associated therewith prompting viewers of the web page to generate an entry regarding any desired topic (e.g., whether or not related to the content of the web page). In some embodiments, the viewers may share their thoughts directly on the web page. In some embodiments, the viewers are directed to another web page or platform to share their thoughts. In some embodiments, the viewers may click on a desired color within the graphical object 722 to share their thoughts, for example, to express sentiment regarding a particular topic. In some embodiments, the thoughts or entries from the viewers are posted to the web page, for example, via a comment section.

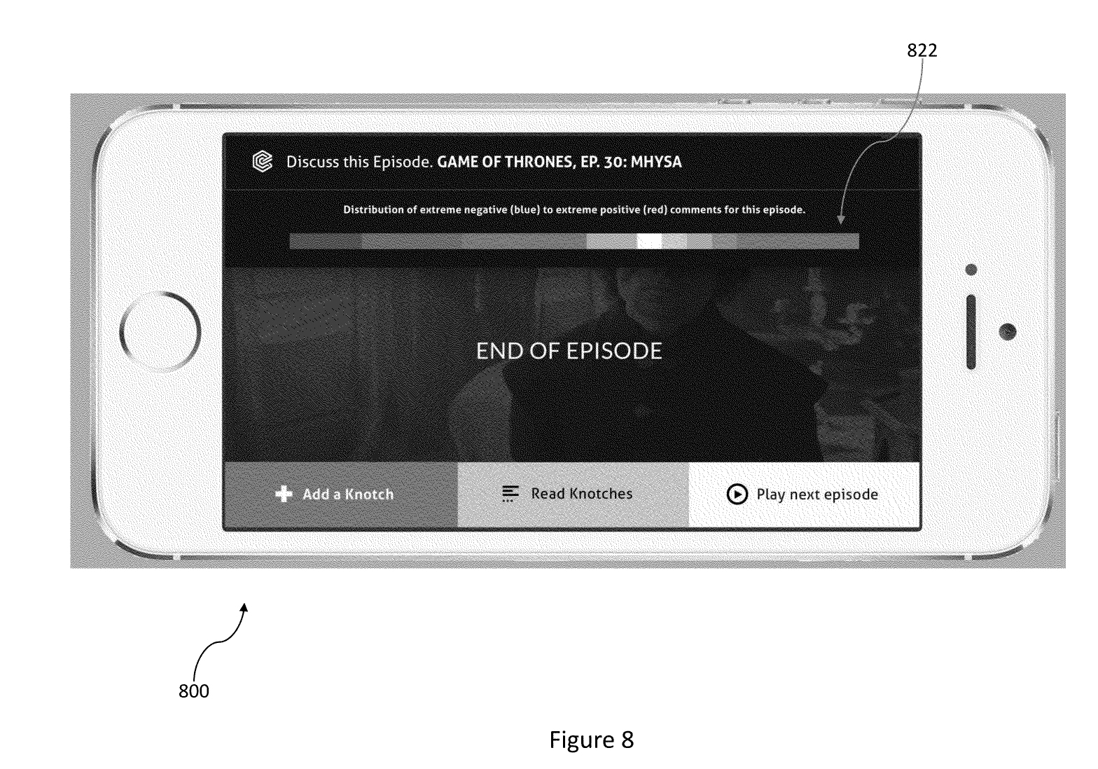

Referring now to FIG. 8, a screen shot 800 of a tool, for example, smartphone application, web page, etc., for rating content is shown. A graphical object 822 comprising one or more colors to be selected by a user for rating content is provided to users. In some embodiments, the graphical object 822 is updated based on user-generated content (e.g., as users generate entries rating the content—e.g., TV show that recently aired—the colors and/or the width of each different-color band is updated). In some embodiments, if no users have selected a particular color (from the colors available for selection) to rate content, that particular color does not appear within the graphical object 822. In some embodiments, users click on or otherwise select a desired color within the graphical object 822, for example, in some embodiments, the graphical object 822 includes all the colors that are available for selection and users choose a desired color.

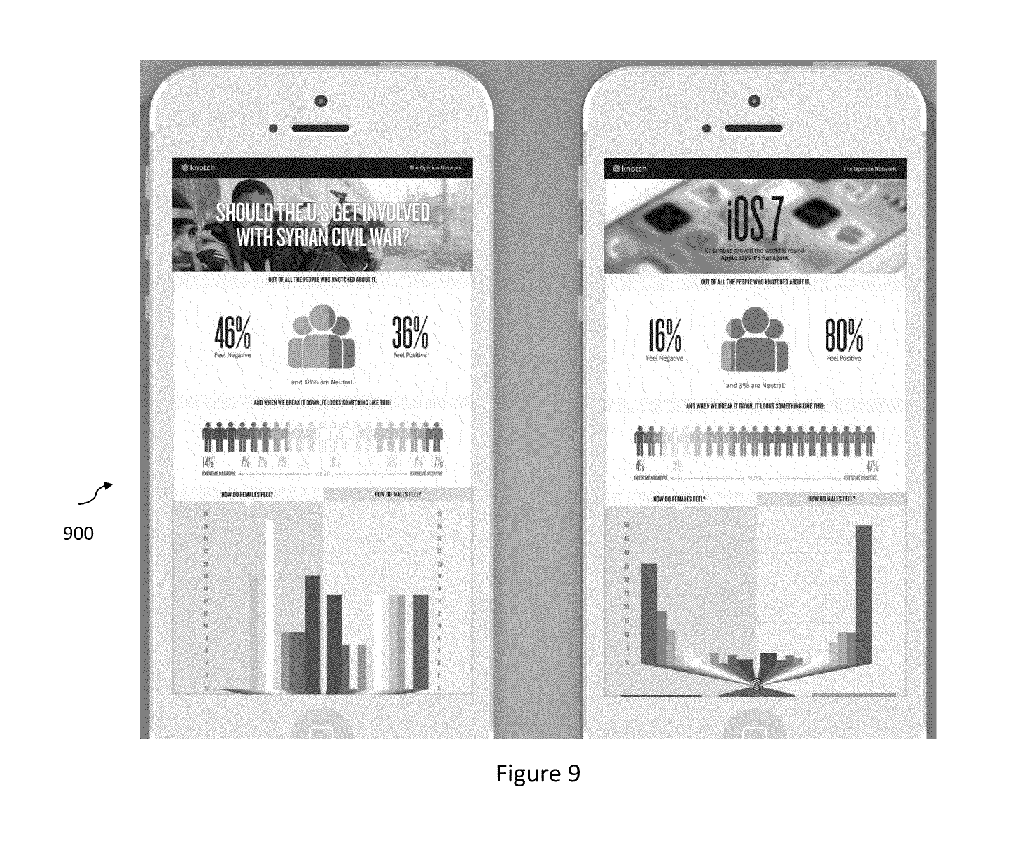

Referring now to FIG. 9, example charts generated based on user rating data are shown. In some embodiments, users generate data regarding any topic. In the examples shown in FIG. 9, users made entries regarding whether U.S. should get involved with Syrian civil war (on the left) and regarding iOS7 (on the right). In some embodiments, the data may be collected via a news web page; a user may read a news story and decide to make an entry regarding that news entry. The user then selects an appropriate sentiment and color to associate with, for example, the news story the user just read or, for example, a particular topic (e.g., iOS7). Some embodiments discussed herein relate to compiling the data generated by users into color distribution graphs to demonstrate how a group of users feels about a particular topic. The color distribution graphs may be organized according to any desired criteria. In some embodiments, the criteria include age of the users, sex of the users, percent positive sentiment versus percent negative sentiment, and any other organization criteria, and any combination thereof. As shown in FIG. 9, the number of users who chose a particular sentiment may be displayed on the chart as well.

In some embodiments, the color distribution chart is generated contemporaneously with an event taking place, for example, a live show, news event, sports game, to gauge and display the current sentiment regarding a particular event or subject. In contrast with simple polling, some embodiments described herein enable the creation of meaningful color distribution charts that display a full range of sentiment regarding a topic of interest (as opposed to mere like/dislike/neutrality regarding the topic). In some embodiments, the users may express their sentiment via any platform, including but not limited to, social networking applications, web page, smartphone application, text message, and any other platform where a user has the ability to make a color selection. In some embodiments, selections from users across different platforms may be compiled into one color distribution chart.

In some embodiments, in addition to selecting a color, a user has the option of leaving optional commentary regarding the selected topic. The commentary may include any statements from the user regarding the selected topic.

In some embodiments, once a user selects the topic and color, and optionally provides a comment regarding the topic, that user's input is displayed to other users who browse this topic and/or to users who visit that user's home page. In some embodiments, each user has a home page associated with that user. In some embodiments, each user has a graphical object, for example, a color thermometer, associated with that user. In some embodiments, each topic has a graphical object, for example, a color thermometer, associated with that topic. In some embodiments, the graphical object is composed of a plurality of different-colored bands. In some embodiments, the presence of each color of the plurality of different colors within the graphical object is determined based on updates posted by users (e.g., each color is present only if a user has previously selected that color for an update; for example, in some embodiments, the color white represents neutral sentiment regarding a topic—if no user has previously selected the color white, no white bands would be present within the graphical object). In some embodiments, the length of each band of the plurality of different-colored bands is determined by the number of users who have used that particular color for expressing their sentiment regarding the chosen topic (e.g., the higher the number of users and/or updates using a particular color, the longer the length of the band of that particular color).

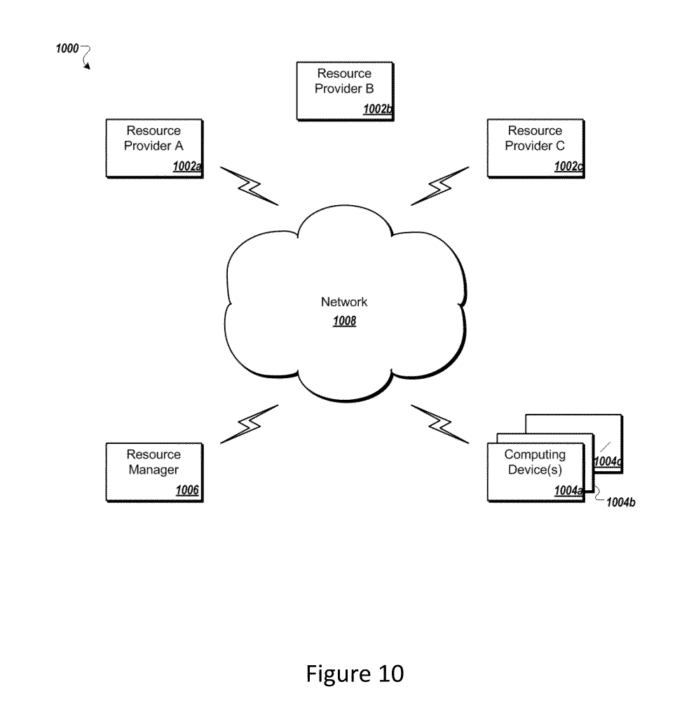

FIG. 10 shows an illustrative network environment 1000 for use in the methods and systems for displaying compiled sentiment data on a plurality of user-specified and/or user-selected topics, as described herein. In brief overview, referring now to FIG. 10, a block diagram of an exemplary cloud computing environment 1000 is shown and described. The cloud computing environment 1000 may include one or more resource providers 1002a, 1002b, 1002c (collectively, 1002). Each resource provider 1002 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 1002 may be connected to any other resource provider 102 in the cloud computing environment 1000. In some implementations, the resource providers 1002 may be connected over a computer network 1008. Each resource provider 1002 may be connected to one or more computing device 1004a, 1004b, 1004c (collectively, 1004), over the computer network 1008.

The cloud computing environment 1000 may include a resource manager 1006. The resource manager 1006 may be connected to the resource providers 1002 and the computing devices 1004 over the computer network 1008. In some implementations, the resource manager 1006 may facilitate the provision of computing resources by one or more resource providers 1302 to one or more computing devices 1004. The resource manager 1006 may receive a request for a computing resource from a particular computing device 1004. The resource manager 1006 may identify one or more resource providers 1002 capable of providing the computing resource requested by the computing device 1004. The resource manager 1006 may select a resource provider 1002 to provide the computing resource. The resource manager 1006 may facilitate a connection between the resource provider 1002 and a particular computing device 1004. In some implementations, the resource manager 1006 may establish a connection between a particular resource provider 1002 and a particular computing device 1004. In some implementations, the resource manager 1006 may redirect a particular computing device 1004 to a particular resource provider 1002 with the requested computing resource.

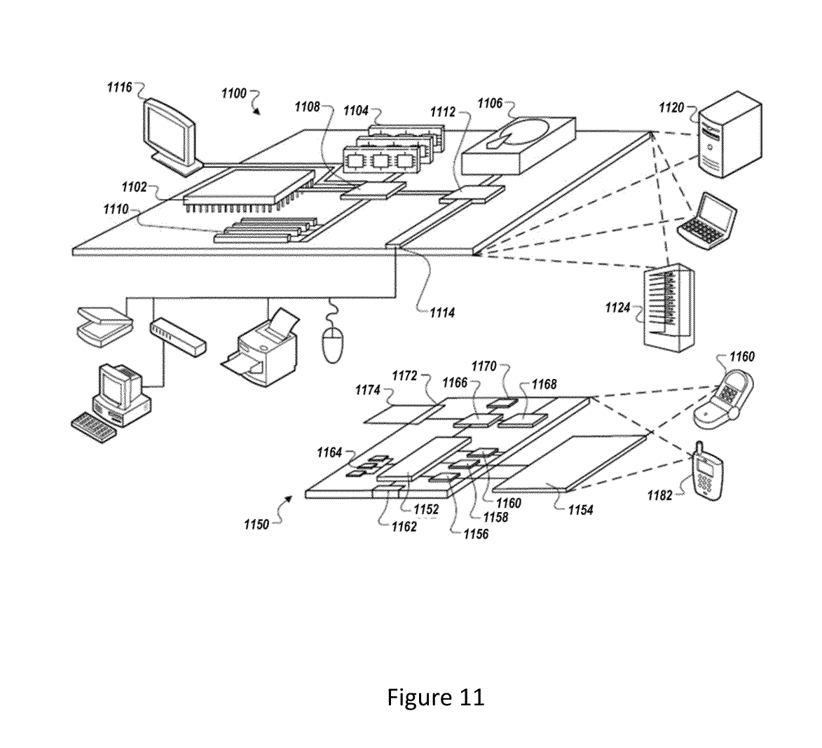

FIG. 11 shows an example of a computing device 1100 and a mobile computing device 1150 that can be used in the methods and systems described in this disclosure. The computing device 1100 is intended to represent various forms of digital computers, such as laptops, desktops, workstations, personal digital assistants, servers, blade servers, mainframes, and other appropriate computers. The mobile computing device 1150 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1100 includes a processor 1102, a memory 1104, a storage device 1106, a high-speed interface 1108 connecting to the memory 1104 and multiple high-speed expansion ports 1110, and a low-speed interface 1112 connecting to a low-speed expansion port 1114 and the storage device 1106. Each of the processor 1102, the memory 1104, the storage device 1106, the high-speed interface 1108, the high-speed expansion ports 1110, and the low-speed interface 1112, are interconnected using various busses, and may be mounted on a common motherboard or in other manners as appropriate. The processor 1102 can process instructions for execution within the computing device 1100, including instructions stored in the memory 1104 or on the storage device 1106 to display graphical information for a GUI on an external input/output device, such as a display 1116 coupled to the high-speed interface 1108. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1104 stores information within the computing device 1100. In some implementations, the memory 1104 is a volatile memory unit or units. In some implementations, the memory 1104 is a non-volatile memory unit or units. The memory 1104 may also be another form of computer-readable medium, such as a magnetic or optical disk.

The storage device 1106 is capable of providing mass storage for the computing device 1100. In some implementations, the storage device 1106 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1102), perform one or more methods, such as those described above. The instructions can also be stored by one or more storage devices such as computer- or machine-readable mediums (for example, the memory 1104, the storage device 1106, or memory on the processor 1102).

The high-speed interface 1108 manages bandwidth-intensive operations for the computing device 1100, while the low-speed interface 1112 manages lower bandwidth-intensive operations. Such allocation of functions is an example only. In some implementations, the high-speed interface 1108 is coupled to the memory 1104, the display 1116 (e.g., through a graphics processor or accelerator), and to the high-speed expansion ports 1110, which may accept various expansion cards (not shown). In the implementation, the low-speed interface 1112 is coupled to the storage device 1106 and the low-speed expansion port 1114. The low-speed expansion port 1114, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 1100 may be implemented in a number of different forms, as shown in the figure. For example, it may be implemented as a standard server 1120, or multiple times in a group of such servers. In addition, it may be implemented in a personal computer such as a laptop computer 1122. It may also be implemented as part of a rack server system 1124. Alternatively, components from the computing device 1100 may be combined with other components in a mobile device (not shown), such as a mobile computing device 1150. Each of such devices may contain one or more of the computing device 1100 and the mobile computing device 1150, and an entire system may be made up of multiple computing devices communicating with each other.

The mobile computing device 1150 includes a processor 1152, a memory 1164, an input/output device such as a display 1154, a communication interface 1166, and a transceiver 1168, among other components. The mobile computing device 1150 may also be provided with a storage device, such as a micro-drive or other device, to provide additional storage. Each of the processor 1152, the memory 1164, the display 1154, the communication interface 1166, and the transceiver 1168, are interconnected using various buses, and several of the components may be mounted on a common motherboard or in other manners as appropriate.

The processor 1152 can execute instructions within the mobile computing device 1150, including instructions stored in the memory 1164. The processor 1152 may be implemented as a chipset of chips that include separate and multiple analog and digital processors. The processor 1152 may provide, for example, for coordination of the other components of the mobile computing device 1150, such as control of user interfaces, applications run by the mobile computing device 1150, and wireless communication by the mobile computing device 1150.

The processor 1152 may communicate with a user through a control interface 1158 and a display interface 1156 coupled to the display 1154. The display 1154 may be, for example, a TFT (Thin-Film-Transistor Liquid Crystal Display) display or an OLED (Organic Light Emitting Diode) display, or other appropriate display technology. The display interface 1156 may comprise appropriate circuitry for driving the display 1154 to present graphical and other information to a user. The control interface 1158 may receive commands from a user and convert them for submission to the processor 1152. In addition, an external interface 1162 may provide communication with the processor 1152, so as to enable near area communication of the mobile computing device 1150 with other devices. The external interface 1162 may provide, for example, for wired communication in some implementations, or for wireless communication in other implementations, and multiple interfaces may also be used.

The memory 1164 stores information within the mobile computing device 1150. The memory 1164 can be implemented as one or more of a computer-readable medium or media, a volatile memory unit or units, or a non-volatile memory unit or units. An expansion memory 1174 may also be provided and connected to the mobile computing device 1150 through an expansion interface 1172, which may include, for example, a SIMM (Single In Line Memory Module) card interface. The expansion memory 1174 may provide extra storage space for the mobile computing device 1150, or may also store applications or other information for the mobile computing device 1150. Specifically, the expansion memory 1174 may include instructions to carry out or supplement the processes described above, and may include secure information also. Thus, for example, the expansion memory 1174 may be provided as a security module for the mobile computing device 1150, and may be programmed with instructions that permit secure use of the mobile computing device 1150. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 1152), perform one or more methods, such as those described above. The instructions can also be stored by one or more storage devices, such as one or more computer- or machine-readable mediums (for example, the memory 1164, the expansion memory 1174, or memory on the processor 1152). In some implementations, the instructions can be received in a propagated signal, for example, over the transceiver 1168 or the external interface 1162.

The mobile computing device 1150 may communicate wirelessly through the communication interface 1166, which may include digital signal processing circuitry where necessary. The communication interface 1166 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1168 using a radio-frequency. In addition, short-range communication may occur, such as using a Bluetooth®, Wi-Fi™, or other such transceiver (not shown). In addition, a GPS (Global Positioning System) receiver module 1170 may provide additional navigation- and location-related wireless data to the mobile computing device 1150, which may be used as appropriate by applications running on the mobile computing device 1150.

The mobile computing device 1150 may also communicate audibly using an audio codec 1160, which may receive spoken information from a user and convert it to usable digital information. The audio codec 1160 may likewise generate audible sound for a user, such as through a speaker, e.g., in a handset of the mobile computing device 1150. Such sound may include sound from voice telephone calls, may include recorded sound (e.g., voice messages, music files, etc.) and may also include sound generated by applications operating on the mobile computing device 1150.

The mobile computing device 1150 may be implemented in a number of different forms, as shown in the figure. For example, it may be implemented as a cellular telephone 1180. It may also be implemented as part of a smart-phone 1182, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

### EQUIVALENTS

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. A method for structuring and displaying compiled sentiment data on a plurality of user-specified and/or user-selected topics, the method comprising:
receiving, over a network from a first user computing device, an entry by a first member, said entry comprising a first selected topic;
displaying, to the first user computing device, a widget comprising a plurality of colors, each color corresponding to a particular sentiment for selection by the first member to be associated with the first selected topic;
receiving, over the network, from the first user computing device, a selection of a color by the first member corresponding to a particular sentiment to be associated with the first selected topic and optionally, receiving, over the network, from the first user computing device, a text entry made by the first member associated with the first selected topic;
providing, to a plurality of members, network-based access for review of the selection by the first member of the color associated with the first selected topic;
compiling, by a processor of a computing device, a plurality of entries of selected colors associated with the first selected topic received from a plurality of members and rendering a substantially linear graphical object composed of differently-colored bands, each band having a length commensurate with a respective proportion of member entries selecting that color for association with the first selected topic; and
providing, to a plurality of members, network-based access for display of the graphical object associated with the first selected topic and optionally, for display of a first widget identifying the first member and the color selected by the first member associated with the first selected topic, and for display of the text entry made by the first member associated with the first selected topic.

2. The method of claim 1, further comprising receiving a request from the first user computing device to follow the first selected topic.

3. The method of claim 1, further comprising receiving a request from the first user computing device to follow a second user computing device.

4. The method of claim 1, further comprising updating the graphical object in real time.

5. The method of claim 4, wherein updating the graphical object comprises adjusting the length of each differently-colored band based on entries received from all users on the first selected topic.

6. The method of claim 1, wherein the length of the graphical object remains constant.

7. The method of claim 1, wherein the first user computing device is registered with a social networking platform.

8. The method of claim 1, further comprising providing to the first user computing device a plurality of topics organized by category.

9. The method of claim 8, further comprising, upon receiving a selection of a category from the first user computing device, displaying to the first user computing device a plurality of sub-topics within the selected category.

10. The method of claim 9, further comprising, displaying to the first user a graphical object associated with each sub-topic.

11. The method of claim 10, further comprising displaying the graphical object directly underneath each sub-topic.

12. The method of claim 1, wherein the graphical object comprises 11 colors.

13. The method of claim 1, wherein the graphical object comprises yellow, blue, and white colors.

14. The method of claim 1, wherein the graphical object comprises a first group of colors indicating varying degrees of positive sentiment associated with the first topic.

15. The method of claim 1, wherein the graphical object comprises a second group of colors indicating varying degrees of negative sentiment associated with the first topic.

16. The method of claim 1, wherein the graphical object comprises colors positioned on opposite ends of the visible color spectrum.

17. A system for structuring and displaying compiled sentiment data on a plurality of user-specified and/or user-selected topics, the system comprising:
a processor; and
a memory, wherein the memory comprises instructions that, when executed by the processor, cause the processor to:
receive, over a network from a first user computing device, an entry by a first member, said entry comprising a first selected topic;
display, to the first user computing device, a widget comprising a plurality of colors, each color corresponding to a particular sentiment for selection by the first member to be associated with the first selected topic;
receive, over the network, from the first user computing device, a selection of a color by the first member corresponding to a particular sentiment to be associated with the first selected topic and optionally, receiving, over the network, from the first user computing device, a text entry made by the first member associated with the first selected topic;
provide, to a plurality of members, network-based access for review of the selection by the first member of the color associated with the first selected topic;
compile, a plurality of entries of selected colors associated with the first selected topic received from a plurality of members and render a substantially linear graphical object composed of differently-colored bands, each band having a length commensurate with a respective proportion of member entries selecting that color for association with the first selected topic; and
provide, to a plurality of members, network-based access for display of the graphical object associated with the first selected topic and optionally, for display of a first widget identifying the first member and the color selected by the first member associated with the first selected topic, and for display of the text entry made by the first member associated with the first selected topic.

18. A non-transitory computer readable medium having instructions stored thereon, wherein the instructions, when executed by a processor, cause the processor to:
receive, over a network from a first user computing device, an entry by a first member, said entry comprising a first selected topic;
display, to the first user computing device, a widget comprising a plurality of colors, each color corresponding to a particular sentiment for selection by the first member to be associated with the first selected topic;
receive, over the network, from the first user computing device, a selection of a color by the first member corresponding to a particular sentiment to be associated with the first selected topic and optionally, receiving, over the network, from the first user computing device, a text entry made by the first member associated with the first selected topic;
provide, to a plurality of members, network-based access for review of the selection by the first member of the color associated with the first selected topic;
compile a plurality of entries of selected colors associated with the first selected topic received from a plurality of members and render a substantially linear graphical object composed of differently-colored bands, each band having a length commensurate with a respective proportion of member entries selecting that color for association with the first selected topic; and
provide, to a plurality of members, network-based access for display of the graphical object associated with the first selected topic and optionally, for display of a first widget identifying the first member and the color selected by the first member associated with the first selected topic, and for display of the text entry made by the first member associated with the first selected topic.
